(19) United States
(12) Patent Application Publication
(10) Pub. No.: US 2013/0311939 A1
(43) Pub. Date: Nov. 21, 2013

(54) INPUT DEVICE AND METHOD FOR CONTROLLING SCROLLING SPEED THEREOF

(71) Applicants: LITE-ON TECHNOLOGY CORPORATION, TAIPEI CITY (TW); LITE-ON ELECTRONICS (GUANGZHOU) LIMITED, GUANGZHOU (CN)

(72) Inventors: YI-PING HSU, NEW TAIPEI CITY (TW); ER-HAO CHEN, NEW TAIPEI CITY (TW); TAO-CHENG YEN, NEW TAIPEI CITY (TW)

(73) Assignees: LITE-ON TECHNOLOGY CORPORATION, TAIPEI CITY (TW); LITE-ON ELECTRONICS (GUANGZHOU) LIMITED, GUANGZHOU (CN)

(21) Appl. No.: 13/897,770

(22) Filed: May 20, 2013

(30) Foreign Application Priority Data
May 21, 2012 (CN) 201210156789.0

(51) Int. Cl. G06F 3/0485

(52) U.S. Cl. CPC G06F 3/0485
USPC 715/784

(57) ABSTRACT

A scrolling speed controlling method of an input device is disclosed. The method includes detecting one or more notches rolled by a scrolling unit of the input device in operation, wherein each notch corresponds to a number of scrolling lines; calculating a time duration between two adjacent notches and determining whether the time duration is smaller than or equal to a threshold time; when the time duration is smaller than or equal to the threshold time, the scrolling unit is determined to roll in a fast-rolling mode and the number of scrolling lines corresponding to each notch is increased progressively; accumulating the numbers of scrolling lines corresponding to the rolled notches to generate an accumulated number of lines; outputting a control command to the computer to instruct the computer to scroll the document according to a designated number of lines instructed by the control command; and subtracting the designated number of lines from the accumulated number of lines.

### BACKGROUND OF THE INVENTION

1. Field of the Invention

The instant disclosure relates to an input device and a method for controlling scrolling speed thereof; in particular, to an input device of a computer and a method for controlling scrolling speed thereof.

2. Description of Related Art

A scrollable component such as a roller or a trackball is often disposed on an input device of a computer, such as a mouse or a keyboard, for a user to control scrolling of a webpage or a file shown on a computer screen When the user operates the scrollable component, no matter what the user's operating speed is, the number of scrolling lines of the computer corresponding to each rolling unit is the same. The relation between the number of rolling notches of the scrollable component and the number of scrolling lines of the computer is usually set in the computer system. For example, the user may set the number of scrolling lines corresponding to the number of rolling notch in the console of the windows operating system so that each notch rolled by the roller or trackball corresponds to single line, a plurality of lines or one page.

Although the user may set or adjust the number of scrolling lines corresponding to the number of rolling notch, the computer just scrolls according to the constant value. For example, the user set that one notch rolled by the roller corresponds one line scrolled by the computer, so the one hundred notch rolled by the roller corresponds one hundred line scrolled by the computer. Accordingly, the way of the operating is prone to cause the inconvenience of operating the document for the user, in particular, to cause the inconvenience of operating the lengthy document. Moreover, the way of the operating is prone to cause a waste of time and do a harm to the user's hand due to the excessive use.

### SUMMARY OF THE INVENTION

The instant disclosure provides an input device adapted for connecting to a computer. The input device includes a scrolling unit and a control unit. The scrolling unit is used for rolling one or more notches according to operation and each notch rolled by the scrolling unit is corresponding to a number of scrolling lines associated with a document of the computer. The control unit connected to the scrolling unit calculates a time duration between two adjacent notches rolled by the scrolling unit so as to determine whether the scrolling unit is in a fast-rolling mode or in a slow-rolling mode when the scrolling unit rolling, and then accumulates respective numbers of scrolling lines corresponding to the respective notches rolled by the scrolling unit to generate an accumulated number of lines, and outputs a control command to the computer to instruct the computer to scroll the document according to a designated number of lines.

When the time duration between two adjacent notches is smaller than or equal to a threshold time, the control unit determines the scrolling unit in the fast-rolling mode and progressively increases the number of scrolling lines corresponding to each notch rolled by the scrolling unit in the fast-rolling mode.

Additionally, the control unit subtracts the designated number of lines from the accumulated number of lines, wherein the designated number of lines is instructed by the control command.

Furthermore, the instant disclosure provides a method for controlling a scrolling speed of an input device connecting to a computer. The method includes as follows: detecting a rolling state of a scrolling unit of the input device when the input device is in operation, wherein the scrolling unit rolls one or more notches according to operation, and each notch rolled by the scrolling unit corresponds to a number of scrolling lines associated with a document in the computer; calculating a time duration between two adjacent notches when the scrolling unit rolling; determining whether the time duration is smaller than or equal to a threshold time; determining that the scrolling unit rolls in a fast-rolling mode, and progressively increasing the respective numbers of scrolling lines corresponding to the respective notches being rolled by the scrolling unit when the time duration is smaller than or equal to the threshold time; accumulating the numbers of scrolling lines corresponding to the notches rolled by the scrolling unit to be an accumulated number of lines; outputting a control command to the computer so as to instruct the computer to scroll the document according to a designated number of lines instructed by the control command; and subtracting the designated number of lines from the accumulated number of lines.

In summary, an embodiment of the instant disclosure provides the input device and scrolling speed control method thereof. The above-mentioned input device and scrolling speed control method thereof determines the state of the scrolling speed according to a time interval of two adjacent notches rolled by the scrolling unit of the input device, and then automatically controls the number of scrolling lines of the document of the computer, and thus when the scrolling unit fast-forward, the document may significantly scroll with that. More specially, the longer time the scrolling unit fast-forward, the more scrolling range of the document increases, and thus the user may quickly reach the desired content which—is relatively located far location of the document.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

FIG. 1 shows a schematic diagram illustrating the operation of an input device, according to a preferred embodiment of the instant disclosure;

FIG. 2 shows a block diagram of the input device, according to a preferred embodiment of the instant disclosure;

FIGS. 3A˜3B shows schematic diagrams for scrolling the document corresponding to the input device in the slow-rolling mode, according to the preferred embodiment of the instant disclosure;

FIGS. 4A˜4B shows schematic diagrams for scrolling the document corresponding to the input device in the fast-rolling mode, according to the preferred embodiment of the instant disclosure;

FIG. 5 shows a flow diagram illustrating a method of accumulating the number of scrolling lines for an input device controlling a scrolling speed, according to a preferred embodiment of the instant disclosure;

FIG. 6 shows a flow diagram illustrating a method of an input device instructing a computer to perform a scrolling operation for the input device controlling a scrolling speed, according to a preferred embodiment of the instant disclosure;

FIG. 7 shows a flow diagram illustrating a method of accumulating the number of scrolling lines for an input device controlling a scrolling speed, according to another preferred embodiment of the instant disclosure;

FIG. 8A shows a coordinate view of time v.s. a number of scrolling lines according to one preferred embodiment of the instant disclosure;

FIG. 8B shows a coordinate view of time v.s. a designated number of scrolling lines according to the preferred embodiment of the instant disclosure; and

FIG. 8C shows a coordinate view of time v.s. an accumulated number of lines according to the preferred embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment of an Input Device for Controlling Scrolling Speed]

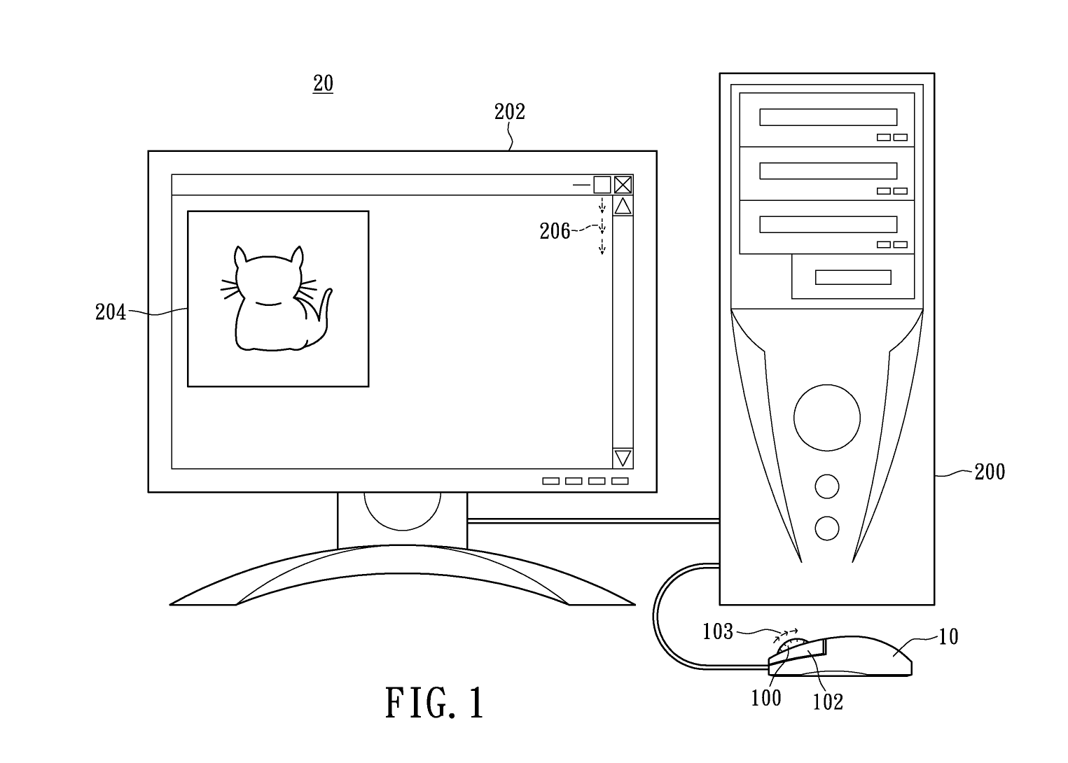

FIG. 1 shows a schematic diagram of an input device for controlling a scrolling speed of a document of a computer according to a preferred embodiment of the instant disclosure. As shown in FIG. 1, the input device 10 may be a mouse having a scrolling unit 100 and a push button 102, and is used to connect to a computer 20 including a host 200 and a display 202. In another embodiment, the input device 10 may be wirelessly connected to the computer 20. The scrolling unit 100 of the input device 10 may be a scrolling wheel or a trackball and corresponds to a plurality of notches. The notch is the smallest unit of the scrolling unit 100 to roll, and each of the plurality of notches may be set to correspond to one or more numbers of scrolling lines of the document 204 shown by a display 202 of the computer 20. In other words, when the notches are rolled by the scrolling unit 100 of the input device 10 which is operated by the user, e.g., the notches roll three times 103 shown in FIG. 1 the input device 10 can transmit a control command to the host 200 of the computer 20 along with the rolling of the scrolling unit 100, so as to instruct the host 200 to control the document 204 of the display 202 to scroll according to the number notches rolled by the scrolling unit 100, e.g, correspondingly scroll down three lines 206 as shown in FIG. 1.

The mouse shown in FIG. 1 is no more than an embodiment of one of the input devices 10 for controlling the scrolling speed of the document. The input device 10 of the present embodiment also may be other computer peripherals with the scrolling unit, such as a pointing device or a keyboard with the scrolling wheel or the trackball. Furthermore, the connection between the input device 10 and the computer 20 is not restricted to wired connection as shown in FIG. 1. An artisan of ordinary skill in the art may change the design of the input device 10 to communicate with the computer 20 and transmit to commands in a wireless connection way.

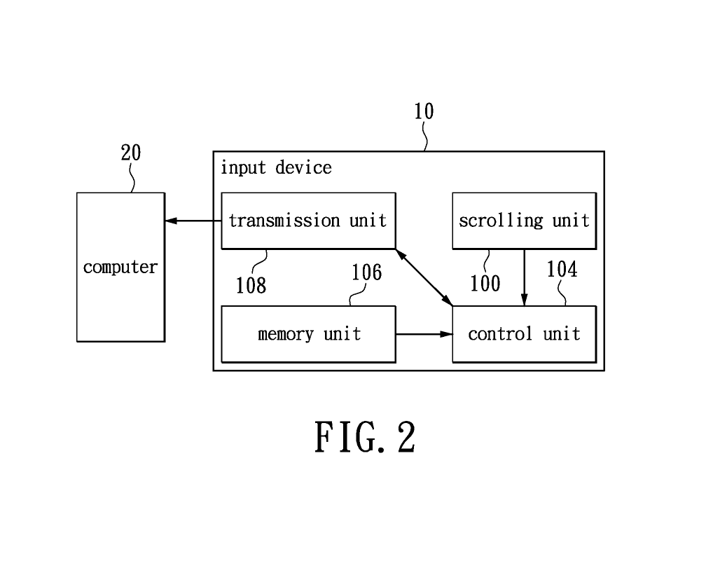

Referring to FIG. 2, FIG. 2 shows a block diagram of the input device according to a preferred embodiment of the instant disclosure. The input device 10 of the present embodiment includes at least a scrolling unit 100, a control unit 104, a memory unit 106 and a transmission unit 108. The scrolling unit 100, the memory unit 106 and the transmission unit 108 are separately electrically connected to the control unit 104 and are separately controlled by the control unit 104. The scrolling unit 100 may be the aforementioned scrolling wheel or a roller, the trackball or a scrolling ring and then the present embodiment takes the roller as an example to illustrate the instant disclosure. The control unit 104 is a main processing and operating center of the input device 10, and the control unit 104 may be a processing chip, such as a micro control unit, a micro processor or an embedded controller. The memory unit 106, which may be a volatile chip or a non-volatile chip, is used for recording a firmware and/or a driver of the input device 10 and a code of calculating the number of the scrolling lines corresponding to the notches. The transmission unit 108 may be, for example, a communication interface of P/S2 port, USB, Bluetooth transmission module chip or other connection way depending on wired connection or wireless connection between the input device 10 and the computer 20.

The scrolling unit 100 includes a plurality of notches. Taking the roller as an example, there are a plurality of nicks which are equidistant on the roller and each of the plurality of nicks can correspond to a notch. Each rotation of one of the plurality of notches makes the document (not shown in FIG. 2) shown on the computer 20 correspondingly scroll a specific number of scrolling lines. The number of the scrolling lines may be one or more lines predefined in accordance with the controlling of the control unit 104, or may be defined by having the control unit 104 operatively assigning each of the plurality of notches correspond to the number of the scrolling lines of different values, so as to fit in with the habit and the demand of scrolling the document for the user. What follows is the detailed description.

The control unit 104 of the present embodiment detects the amount of the notches rolled by the scrolling unit 100 and a time duration between each of the plurality of notches and the previous notch according to the user's operation. The control unit 104 compares the time duration between two adjacent notches with a specific threshold time so as to determine whether the scrolling unit 100 under the user's operation is in a fast-rolling mode or in a slow-rolling mode, and thus the control unit 104 may instruct different numbers of the scrolling lines to correspond to different notches and generate an accumulated number of lines through accumulating the numbers of the scrolling lines corresponding to each notch rolled by the scrolling unit 100. The control unit 104 may output a control command to notify a processor (not shown in FIG. 2) of the computer 20 to scroll a designated number of lines so that the processor may generate the effect of scrolling the document according to the designated number of lines instructed by the control command. The control unit 104 instructs the designated number of lines that the computer 20 should scroll according to the accumulated number of lines, and the designated number of lines instructed by the control command may be one or more lines depending on the amount of the accumulated number of lines.

It is worth mentioning that the way of outputting the control command of the control unit 104 may be to output the control command intermittently and irregularly, or to output the control command with a specific period. For example, the control unit 104 may output the control command periodically or output the control command before a specific time is expired. However,\whether the control unit 104 outputs the control command periodically is not restricted thereto, so long as the control unit 104 can output the control command to the computer 20 to scroll the document.

When the scrolling unit 100 scrolls, the control unit 104 calculates the time duration between two adjacent notches and compares the time duration with the threshold time. When the time duration between two adjacent notches is larger than the threshold time, the control unit 104 determines the scrolling unit 100 as being in the slow-rolling mode. On the contrary, when the time duration between two adjacent notches is smaller than or equal to the threshold time, the control unit 104 determines the scrolling unit 100 as being in the fast-rolling mode. For example, if the threshold time is set to be 100 milliseconds, when the time duration between two adjacent notches rolled by the scrolling unit 100 is larger than 100 milliseconds, the scrolling unit 100 is determined as being in the slow-rolling mode. On the contrary, when the time duration between two adjacent notches is smaller than or equal to 100 milliseconds, the scrolling unit 100 is determined as being in the fast-rolling mode.

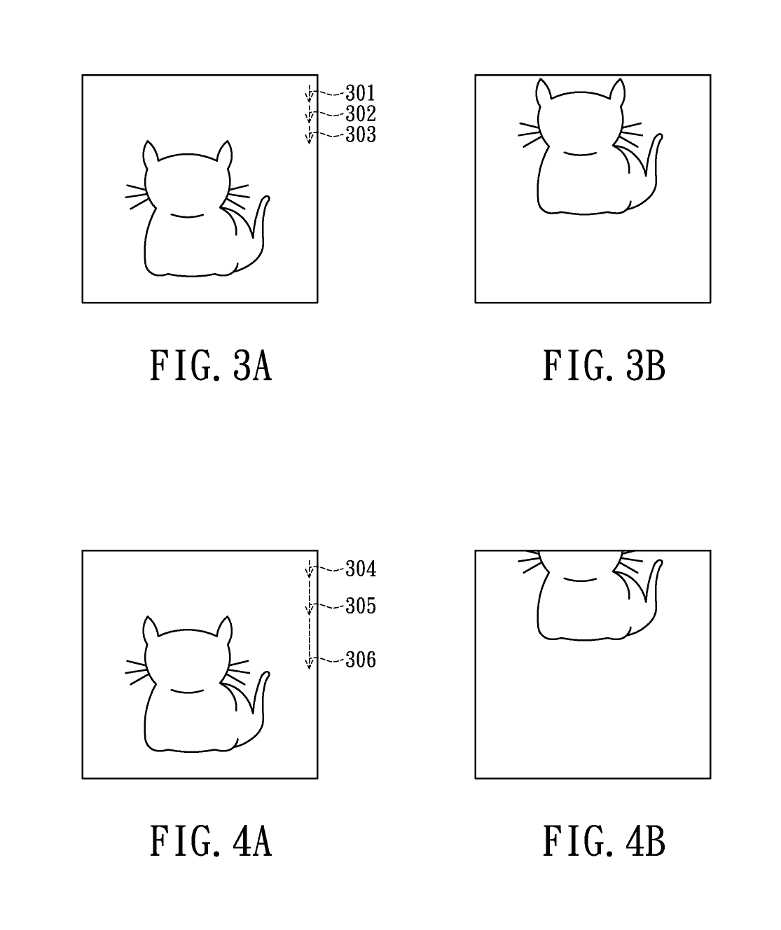

When the scrolling unit 100 is in the slow-rolling mode, it may mean that the user is slowly watching the document shown on the display of the computer 20, and thus the control unit 104 may instruct each notch rolled by the scrolling unit 100 corresponding to the same basic number of lines. For example, one notch rolled by the scrolling unit 100 corresponds to one line, or one notch rolled by the scrolling unit 100 corresponds to the same multiple lines. In other words, when the user slowly rolls the scrolling unit 100, the document shown on the display of the computer 20 will slowly scroll correspondingly. Furthermore, referring to FIG. 3A, which is a schematic view of display of the document, if the basic number of lines is set to be one line and when the scrolling unit is in the slow-rolling mode, when the scrolling unit rolls three notches backward, the document will correspondingly scroll three lines downward (i.e. from 301 to 302 to 303) and thus the contents of the document shown will change from FIG. 3A to FIG. 3B.

On the other hand, when the scrolling unit 100 is in the fast-rolling mode, it means that the user may want to quickly change the contents of the document shown on the display of the computer 20 so as to watch different parts of the document. Meanwhile, the control unit 104 may calculate according to a formula to make each notch rolled by the scrolling unit 100 correspond to different values of the number of scrolling lines. Also, the longer the scrolling unit 100 is in the fast-rolling mode, more number of scrolling lines are instructed to each notch rolled by the scrolling unit 100 in the fast-rolling mode, wherein the number of scrolling lines increases sequentially according to the sequence of the notch rolled by the scrolling unit 100. In other words, referring to FIG. 4A, in the fast-rolling mode, the number of scrolling lines corresponding to each notch is more than that corresponding to its previous notch. Therefore, if the scrolling unit 100 quickly rolls three notches backward, the document will sequentially increases the numbers of scrolling lines downward; that is, the numbers of scrolling lines 304, 305 and 306 shown in the FIG. 4A are sequentially increased such that the shifting range of the displayed contents of the document, as shown in FIG. 4A to FIG. 4B, is larger than the shifting range shown from FIG. 3A to FIG. 3B. Thus, when the scrolling unit 100 is in the fast-rolling mode, more and more lines are to be scrolled by the computer 20, so that the user may easily shift the display range of the document significantly.

When the control unit 104 determines the time duration between two adjacent notches is smaller than or equal to the threshold time, the control unit 104 can calculate the numbers of scrolling lines corresponding to the notches according to a formula such as the formula of arithmetic series or the formula of geometric series and the sequence of the notches rolled by the scrolling unit in the fast-rolling mode. Taking arithmetic series with common difference of 2 as an example, the number of scrolling lines corresponding to a first notch rolled by the scrolling unit 100 in the fast-rolling mode, is one line, the number of scrolling lines corresponding to a second notch rolled by the scrolling unit 100 is three lines, the number of scrolling lines corresponding to a third notch rolled by the scrolling unit 100 is five lines, and so on. The numbers of scrolling lines are progressively increased until the scrolling unit 100 stops rolling or is determined by the control unit 100 to change from the fast-rolling mode to the slow-rolling mode. In comparison to each notch corresponding to one line while the scrolling unit is in the slow-rolling mode, when the scrolling unit 100 rolls three notches in the fast-rolling mode, the scrolling unit 100 accumulates nine lines of the number of scrolling lines. Thus, under the same amount of notches rolled (e.g., three notches), more number of the scrolling lines(e.g., six more lines) are instructed in the fast-rolling mode in compared to the numbers of scrolling lines instructed in the slow-rolling mode.

Besides determining the rolling mode of the scrolling unit 100 and calculating the number of scrolling lines corresponding to each notch rolled by the scrolling unit 100, the control unit 104 calculates the accumulated number of lines whenever the scrolling unit 100 is rolled. The accumulated number of lines that the computer 20 should scroll comes from the identical basic number of lines corresponding to each notch in the slow-rolling mode and the different numbers of scrolling lines corresponding to each notch in the fast-rolling mode according to the calculating of the formula. The accumulated number of lines may be temporarily stored in the memory unit 106.

When the control unit 104 calculates and accumulates the numbers of scrolling lines in the process of the input device's operation, the control unit 104 may periodically generate a control command according to a period and transmits the control command to the computer 20 through a transmission unit 108 so as to instruct the computer 20 to scroll the document in response to the operation of the input device 10. The period (e.g., a period of 40 milliseconds) is configured by the control unit 104, wherein the period may be an initial period predefined in a firmware of the input device 10, or the control unit 104 can operatively set the duration of the period, or configured by other equivalent means. The control unit 104 outputs the control command including a designated number of lines that the computer should scroll according to the period of 40 milliseconds. In the present embodiment, suppose that the designated number of lines is one line, every time when the control unit 104 transmits the control command to the computer, the computer 20 is instructed to scroll one line. After the control unit 104 outputs the control command including the designated number of lines, the control unit 104 subtracts the outputted designated number of lines from the accumulated number of lines that is temporarily stored, and updates the temporarily stored record. Thus, the control unit 104 may calculate the number of scrolling lines that the computer 20 should scrolled, and then when the time of period is expired again, the control unit 104 will instruct the computer 20 to continuously scroll the remaining number of scrolling lines.

Therefore, when the user operates the input device 10 with the scrolling unit 100, besides continuously calculating and accumulating the accumulated number of lines that the computer 20 should scroll, the control unit 104 periodically continues to instruct the computer 20 to execute the scrolling of the designated number of lines so as to consume the lines that have not been scrolled yet along with fast or slow rolling operations of the scrolling unit 100. Thus, when the user operates the scrolling unit 100 of the input device 10 quickly or slowly, the effect of correspondingly scrolling the document slightly or significantly can be achieved.

Furthermore, in the present embodiment, besides executing the aforementioned controls so that the scrolling range varies with the adjustment of the scrolling speed, the control unit 104 can control the computer 20 to quickly scroll the document accompanying with the continuous fast-rolling of the scrolling unit 100. Therefore, the number of scrolling lines of the document increases and the speed of scrolling the document increases so that the document may be more quickly scrolled to the desired part of the document that the user want to watch.

For achieving the aforementioned effect, the input device 10 may pre-record a first threshold number of lines served as a benchmark to determine whether the accumulated number of lines waiting to be scrolled by the computer 20, is too many. The control unit 104 may compare and determine whether the accumulated number of lines exceeds the first threshold number of lines. For instance, when the control unit 104 periodically generates and outputs the control command at first according to a first period, such as 40 milliseconds, and the accumulated number of lines exceeds the first threshold number of lines, the control unit 104 may change to periodically generate and output the control command according to a second period. The period time of the second period, such as 20 milliseconds, is shorter than the first period. When the control unit 104 outputs the control command according to the second period with a shorter period time, the control unit 104 may enhance the frequency of indicating the computer 20 to scroll according to the designated number of lines so as to decrease the amount of the accumulated number of lines waiting to be scrolled. Thus, after the control unit 104 continuously accumulates the number of scrolling lines generated from the scrolling unit 100 rolled in the fast-rolling mode or in the slow-rolling mode and the control unit 104 periodically subtracts the outputted designated number of lines from the accumulated number of lines according to the first period, and if the accumulated number of lines is still larger than the first threshold number of lines, the control unit 104 may change to output the control command according to the second period so as to accelerate the elimination of the accumulated number of lines. As far as the exemplary value of the present embodiment is concerned, after changing the period from the first period of 40 milliseconds to the second period of 20 milliseconds, the speed of eliminating of the accumulated number of lines enhances twice or so and the speed of scrolling the document also enhances twice or so.

In the present embodiment, on the one hand, when the control unit 104 outputs the control command to reduce the amount of the accumulated number of lines according to the second period and determines the accumulated number of lines not exceeding the first threshold number of lines after comparing, the control unit 104 can restore to generate and output the control command according to the first period so as to relieve the operation loading of the control unit 104. On the other hand, when the control unit 104 outputs the control command according to the second period and the control unit 104 is not capable of efficiently reducing the accumulated number of lines to being not exceeding the first threshold number of lines, the control unit 104 may increase the designated number of lines, for example, from one line to more lines. Alternatively, the control unit 104 may shorten the period time of outputting the control command, for example, to be 10 milliseconds, so as to more frequently generate and output the control command including the designated number of lines to reducing the value of the accumulated number of lines.

In other words, in the present embodiment, the control unit 104 may increase the scrolling speed of the document through changing either the period time or the designated number of lines, and in the other embodiment, the control unit 104 may still increase the speed of scrolling the document through simultaneously adjusting the period time and the designated number of lines. For example, when the control unit 104 shortens the period time for half the time of the previous period time, the control unit 104 also simultaneously increases the value of the designated number of lines in the control command for the twice so as to increase the scrolling speed of the computer 20 by four times.

[Embodiment of Method of Controlling the Scrolling Speed for an Input Device]

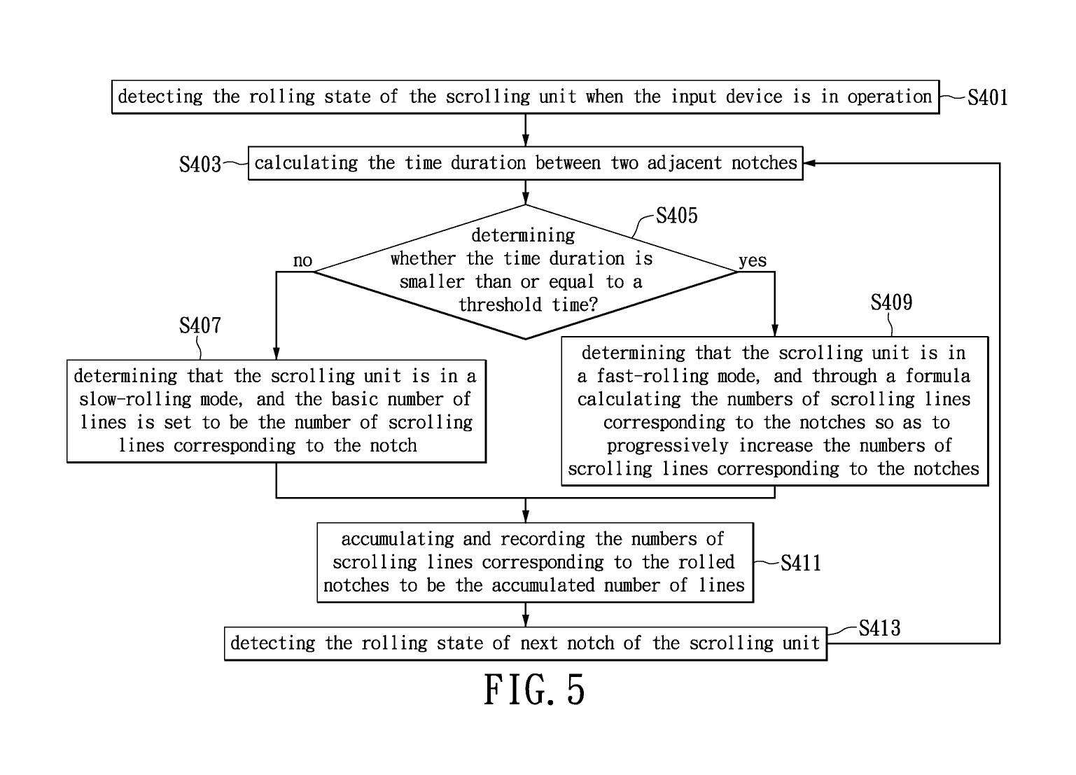

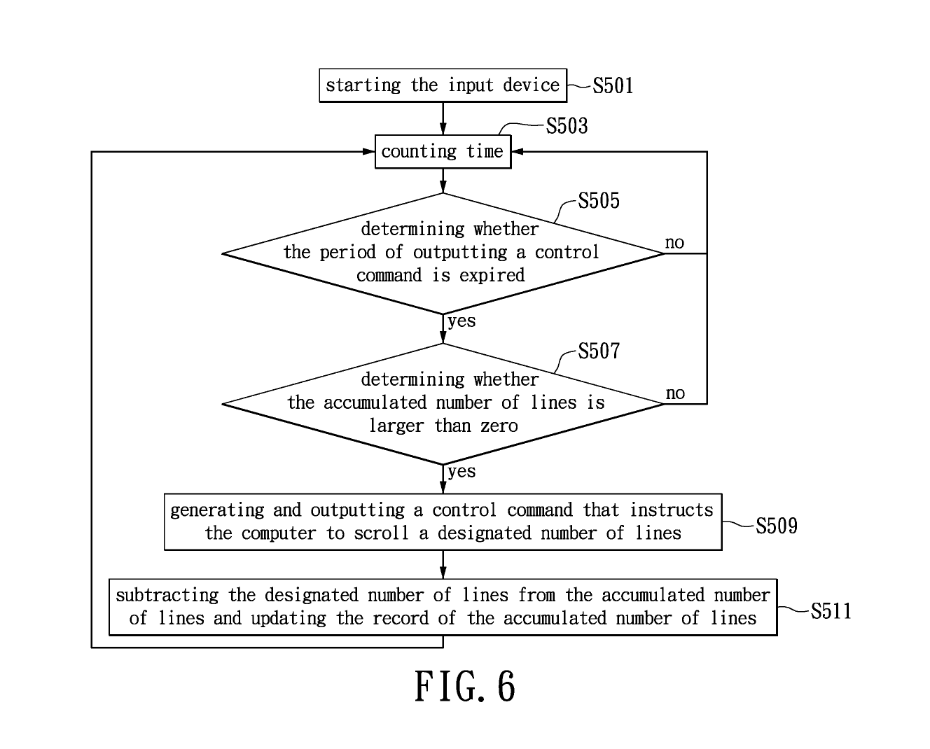

Referring to FIGS. 5 and 6, FIG. 5 shows a flow diagram of accumulating the numbers of scrolling lines according to a preferred embodiment, and FIG. 6 shows a flow diagram in which the input device instructs the computer to scroll according to a preferred embodiment. FIG. 2 is also referred for explanation since the steps in the flows of the present embodiment may be implemented with the input device 10 as shown in FIG. 2.

Firstly, referring to FIG. 5, when the input device 10 connected to the computer 20 is in operation, the control unit 104 may detect the user's operation for the scrolling unit 100. If the user rotates the scrolling unit 100, the control unit 104 may detect one or more notches rolled by the scrolling unit 100 (S401). When the control unit 104 detects the notches, the control unit 104 may calculate a time duration between two adjacent notches (S403), i.e., calculating the difference between the time detected for one notch currently rolled by the scrolling unit 100 and the time detected for the notch previously rolled by the scrolling unit 100. Next, the control unit 100 may read a threshold time and compare the threshold time with the time duration between two adjacent notches so as to determine whether the time duration is smaller than or equal to the threshold time (S405).

In the one hand, according to the results of the comparison, if the time duration is larger than the threshold time, the control unit 104 determines that the scrolling unit 100 is in a slow-rolling mode, and the basic number of lines is set to be the number of scrolling lines corresponding to the notch during the slow-rolling mode (S407). In the other hand, according to the results of the comparison, if the time duration is smaller than or equal to the threshold time, the control unit 104 determines that the scrolling unit 100 is in a fast-rolling mode, and through a formula calculates the number of scrolling lines corresponding to the notch during the fast-rolling mode so as to progressively increase the numbers of scrolling lines corresponding to the notches accompanying with the rolling sequence of the notches in the fast-rolling mode (S409). In other words, when the control unit 104 calculates the number of scrolling lines of any notch corresponding to the fast-rolling mode, the control unit 104 may utilize the formula of the arithmetic series, the formula of the geometric series or other formulas to calculate the numbers of scrolling lines respectively corresponding to the notches detected in sequence by the control unit 104 under the fast-rolling mode. On account of adopting the formula of the arithmetic series or the formula of the geometric series, the number of scrolling lines corresponding to each notch is larger than that corresponding to the previous notch. Taking the geometric series with common ratio 2 as an example, when the scrolling unit 100 is in the fast-rolling mode, the number of scrolling lines corresponding to a first notch is one line, the number of scrolling lines corresponding to a second notch is two lines, the number of scrolling lines corresponding to a third notch is four lines, and the number of scrolling lines corresponding to a fourth notch is eight lines, etc.

After calculating the numbers of scrolling lines corresponding to the notches, the control unit 104 accumulates the number of scrolling lines corresponding to every notch so as to sum up the accumulated number of lines and record the accumulated number of lines (S411). The accumulated number of lines is a sum of the basic number of lines and the numbers of scrolling lines, wherein the basic number of lines is instructed by the control unit 104 (S407) and the number of scrolling lines is calculated according to the formula (S409). After acquiring the accumulated number of lines, the control unit 104 continuously detects rolling state of next notch of the scrolling unit 100 (S413) and again calculates the time duration between the newly detected notch and the previous notch so as to update the accumulated number of lines accompanying with user's operation for the scrolling unit 100 (S405 to S411).

In the other hand, referring to FIG. 6, when the input device 10 starts and begins to operate (S501), the control unit 104 may continuously count time (S503) and determine whether the period time is expired, wherein the period time is set by the control unit 104 or instructed by other way (S505). The period time is a period of periodically generating and outputting the control command. If the period time is not expired, the control unit 104 does not need to output the control command to the computer 20 and only needs to return the step S503 so as to continuously count time, and then determines whether the period time is expired. However, if the control unit 104 determines the period time of outputting the control command is expired according to the result of counting time (i.e. the result of the step S505 is YES), the control unit 104 further determines whether the input device 10 has the accumulated number of lines that should be outputted. In other words, the control unit 104 may determine whether the accumulated number of lines is larger than zero (S507) through reading the address used for recording the accumulated number of lines in the memory unit 106.

When the period time is expired and if the control unit 104 determines the input device 10 does not have the accumulated number of lines that should be outputted, it means that the value of the accumulated number of lines is zero, the control unit 104 is not necessarily to the control command to the computer 20 and only needs to return the step S503 so as to count time. However, if the accumulated number of lines recorded in the input device 10 is larger than zero (i.e. the result of the step S507 is YES), it represents that the input device 10 still has the lines that the computer 20 should scroll. Thus, the control unit 104 may generate the control command including the designated number of lines and transmit the control command to the computer 20 through the transmission unit 108 so as to instruct the processor (not shown in FIG. 2) of the computer 20 to scroll the document according to the designated number of lines of the control command (S509).

After outputting the control command, the control unit 104 further subtracts the designated number of lines which is included in the control command from the accumulated number of lines, and then updates the accumulated number of lines that is recorded so as to reduce the value of the accumulated number of lines, and thus the control unit 104 may correctly reflect the accumulated number of lines that the computer 20 does not have scrolled yet. After completing the updating of the accumulated number of lines, the control unit 104 continuously counts time (S503) so as to determine whether the period time is expired (S505) and again executes the aforementioned corresponding steps according to the result of the determining. Therefore, the control unit 104 may continuously and immediately control the change of the number of scrolling lines and the range of scrolling the document for the computer 20 when the input device 10 is in operation.

According to the aforementioned illustrating, the accumulated number of lines read and determined in the step S507 of FIG. 6 corresponds to the accumulated number of lines recorded in the step S411 of FIG. 5. In the step S511 of FIG. 6, the control unit 104 may subtract the designated number of lines from the accumulated number of lines recorded in the step S411 of the FIG. 5 and update the accumulated number of lines so as to maintain the correctness of the accumulated number of lines.

[Another Embodiment of Method of Controlling the Scrolling Speed for the Input Device]

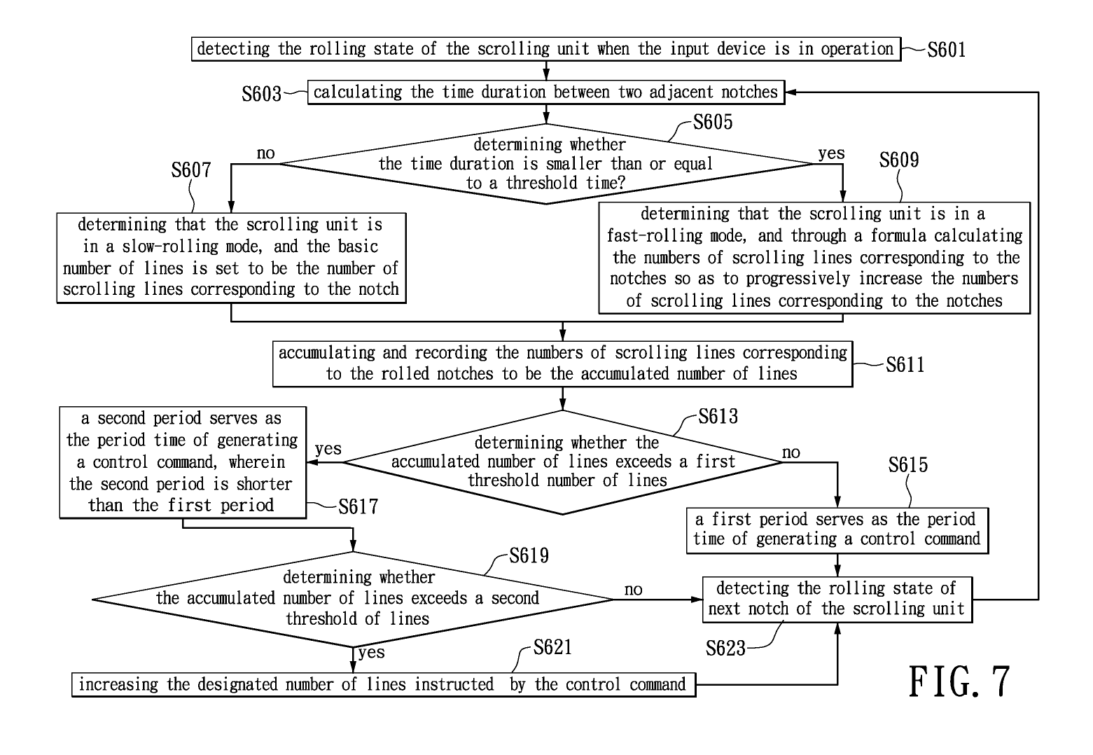

Next, in conjunction with FIGS. 6 and 7, FIG. 7 shows a flow diagram of controlling the scrolling speed for another input device according to a preferred embodiment. The step shown in the present embodiment, besides dynamically changing the range of scrolling the document for the computer through the controlling of the input device, it may further adjust the speed of scrolling the document for the computer cooperated with the operation of the input device. Similarly, the step of the present embodiment may be implemented with the input device shown in the FIG. 2, therefore also referring to FIG. 2 for the convenience of explaining and understanding.

In the present embodiment, the control unit 104 immediately detects the rolling state of the notches of the scrolling unit 100 (S601) and calculates the time duration between two adjacent notches detected sequentially (S603). The control unit 104 compares the time duration with the threshold time so as to determine whether the time duration is smaller than or equal to the threshold time (S605). If the time duration is larger than the threshold time, the control unit 104 determines that the scrolling unit 100 in the slow-rolling mode and the basic number of lines is set to be the number of scrolling lines corresponding to the notches through the control unit 104 (S607). If the time duration is smaller than or equal to the threshold time, the control unit 104 determines that the scrolling unit 100 in the fast-rolling mode and utilizes both the formula and the sequence of the notches in the fast-rolling mode to calculate the number of scrolling lines that is higher than the value of the number of scrolling lines corresponding to the previous notch (S609). Next, the control unit 104 accumulates the number of scrolling lines corresponding to every notch so as to generate and record the accumulated number of lines (S611). The aforementioned steps S601˜S611 are similar to the steps S401˜S411 shown in FIG. 5, therefore please refer to FIG. 5 for detailed descriptions of the steps S601˜S611, and thus there is no need to reiterate.

The difference of the embodiment of FIG. 7 from the embodiment shown in FIG. 5 is that after summing up the accumulated number of lines, the control unit 104 determines whether the accumulated number of lines exceeds a first threshold number of lines (e.g. ten lines) (S613) so as to determine whether the number of scrolling lines accumulates a lot of lines waiting for the computer 20 to scroll due to the scrolling unit 100 in the fast-rolling mode, and then the control unit 104 generates the control command with other different period times. If the accumulated number of lines does not exceed the first threshold number of lines, the control unit 104 is not necessarily to generate control command for changing the period time (e.g. the initial or default period time is a first period), and thus the control unit 104 may maintain the first period served as the period time of generating the control command every time (S615). Next, the control unit 104 continuously detects the rolling state of the next notch of the scrolling unit 100 (S623) and calculates the time duration between the newly detected notch and the previous notch (S603) so as to calculate the number of scrolling lines of the notch and update the accumulated number of lines (S605˜S611). However, if the step S613 determines the accumulated number of lines exceeds the first threshold number of lines, the control unit 104 may change the period time from the first period to the second period and prepare for generating the control command, wherein the second period is shorter than the first period (S617), so as to increase times of scrolling the document for the computer 20 in the same time that the control unit 104 outputs the control command to instruct the computer 20.

In the present embodiment, after the control unit 104 changes the period time for generating the control command from the first period to the second period, the control unit 104 still determines whether the accumulated number of lines exceeds a second threshold of lines (e.g. 15 lines) (S619). If the accumulated number of lines does not exceed the second threshold of lines, the control unit 104 may continuously detect the rolling state of the next notch of the scrolling unit 100 (S623) and execute next steps. After the step S619, if the control unit 104 determines the accumulated number of lines exceeds the second threshold number of lines, the control unit 104 may increase the value of the designated number of lines included in the control command and record the designated number of lines after increasing, and then continuously detect next notch. For example, the designated number of lines change from one line to two or more lines, and thus, when the control unit 104 outputs the control command to the computer 20 every time, the control unit 104 may instruct the computer to scroll two lines or more lines so as to increase both the scrolling speed and range of scrolling document.

In the other hand, in the operation of the input device 10, the control unit 104 may execute the steps shown in the FIG. 6 so as to periodically subtract the accumulated number of lines accumulated in the FIG. 6. Please refer to detailed description shown in FIG. 6 for detailed flow. It is worth mentioning that when corresponding to the embodiment of FIG. 7, the period time shown in the step S505 of FIG. 6 changes with the results of determining whether the accumulated number of lines exceeds the first threshold number of lines shown in the step S613 of FIG. 7. When the accumulated number of lines does not exceed the first threshold number of lines (i.e. the result of the step S613 is NO), the period time determined by the control unit 104 in the step S505 is the first period. When the accumulated number of lines exceeds the first threshold number of lines (i.e. the result of the step S613 is YES), the period time determined by the control unit 104 in the step S505 is the second period.

If the period time adopted by the control unit 104 initially is expired, the control unit 104 may generate the control command including the designated number of lines so as to instruct the computer 20 scrolling the document according to the designated number of lines (step S509 in FIG. 6). The designated number of lines may be one line or more lines according to the results that determines whether the accumulated number of lines exceeds the second threshold number of lines in the step S619. In other words, when the control unit 104 have adjusted the period time from the first period to the second period and determined the accumulated number of lines exceeds the second threshold number of lines, the control unit 104 may increase the value of the designated number of lines (e.g., more lines after increment). When the control unit 104 determines the accumulated number of lines does not exceed the second threshold number of lines, the control unit 104 may recover the value of the designated number of lines to an initial value (e.g. one line).

It is worth mentioning that in the embodiment of FIG. 7, besides determining whether the accumulated number of lines exceeds the second threshold number of lines and whether increases the designated number of lines instructed by the control command according to the determining results (steps S619 and S621), the threshold number of lines may be more than two. Herein, taking the following two examples to illustrate, but the claim is not limited thereto. Example 1: In the embodiment of FIG. 7, the first threshold number of lines is used for determining whether the period of generating the control command for the control unit 104 is the first period or the second period. Moreover, it may add a third threshold number of lines so as to determine whether the control unit 104 generates control command with other period (e.g. shorter than the second period). Example 2: It may add a fourth threshold number of lines so as to determine whether the accumulated number of lines exceeds the fourth threshold number of lines, and thus further enhances the designated number of lines. However, the instant disclosure is not limited the number of the threshold number of lines, the threshold number of lines is used for determining whether to change the period of generating the control command or determining whether to enhance the designated number of lines, and thus the control unit 104 may enhance the speed of eliminating the accumulated number of lines.

Furthermore, the embodiment in FIG. 7 also may eliminate the related step that determines whether the accumulated number of lines exceeds the second threshold number of lines so as to simplify the flow. For example, the step S623 is directly executed after executing the step S617. Because the second period of the embodiment in FIG. 7 is shorter than the first period and when the accumulated number of lines exceeds the first threshold number of lines, the control command may be periodically generated with the second period so as to more quickly eliminate the accumulated number of lines, or determine with the same first threshold number of lines or directly execute the step S621 after executing the step S617, and then the step S623 is executed after the step S621. When the control command is periodically generated with the second period and the designated number of lines is enhanced, the speed for eliminating the accumulated number of lines may be further enhanced.

It is worth mentioning that when the control command is periodically generated with the first period (or with the second period) according to the step of FIG. 7, there are a variety of methods for calculating the period. The embodiment only lists two kinds of method for calculating the period, but the instant disclosure is not limited thereto.

### Example A

Each time after determining whether the accumulated number of lines exceeds the first threshold number of lines (i.e. step S621), the period time may be counted again so that when the accumulated number of lines changes, the period time for generating the control command would be counted again. Taking one situation for explaining, herein, suppose that the first period is 40 milliseconds and the second period is 20 milliseconds. When counting time with the first period and the first period is not expired (e.g. 30 milliseconds), meanwhile, if the accumulated number of lines generated by the scrolling unit 100 exceeds the first threshold number of lines, the period time changes from the first period to the second period according to the determining result of the step S613. At this time, the control command with the first period has not been generated yet and the control command will be generated after re-counts 20-millisecond period time. In other words, in this situation, the time interval between the control command before changing the period time and the control command after changing the period time is 50 milliseconds. According to the aforementioned, changing in the period time may result in extending the time interval of the control command, which only happens when the period time changes, and would cause the period time generated from the control command in whole being not just simply the first period or the second period.

### Example B

When the period for generating the control command changes according to the result of the step S613, the next control command may be firstly generated according to the period time before changing the period and the control command following by the next control command may be periodically generated according to the period time after the period has been changed. In other words, Example B may avoid the situation of Example A, that the change of period time may extend the time interval of generating the control command, and thus the period time for generating the control command in example B is either the first period or the second period. The difference between Example A and Example B is only in the time interval associated with the control command generated when the period time has been changed. In whole, neither Example A nor Example B affects the speed of reducing the accumulated number of lines.

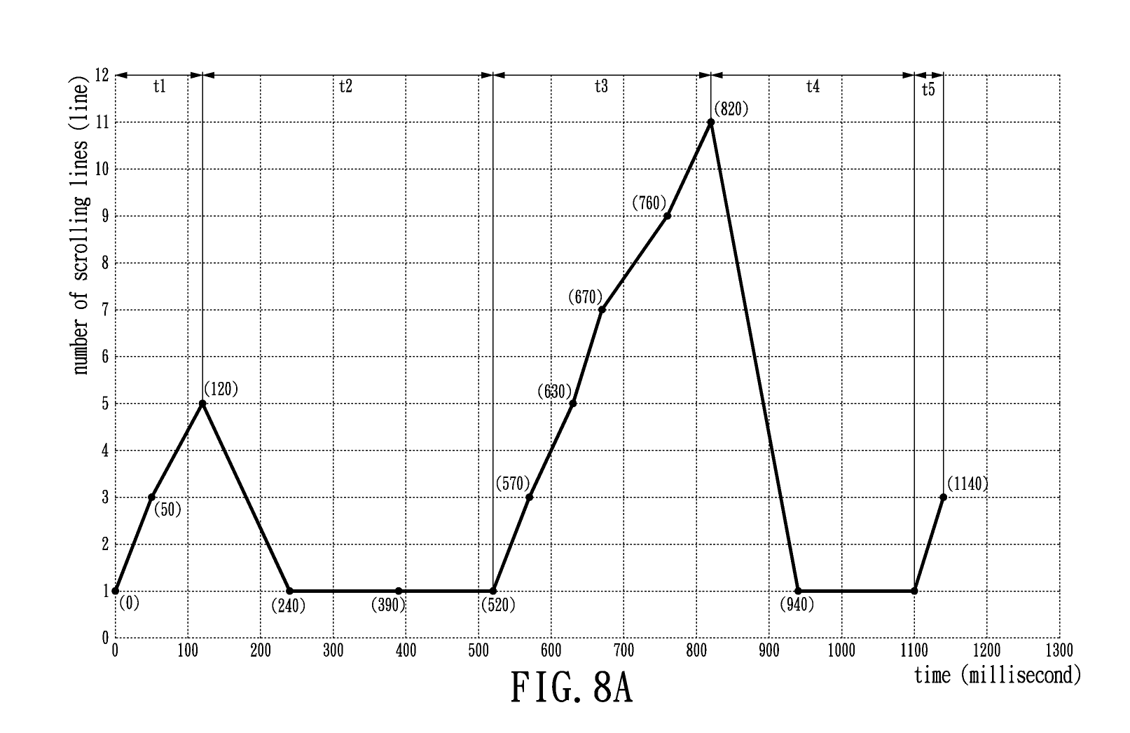

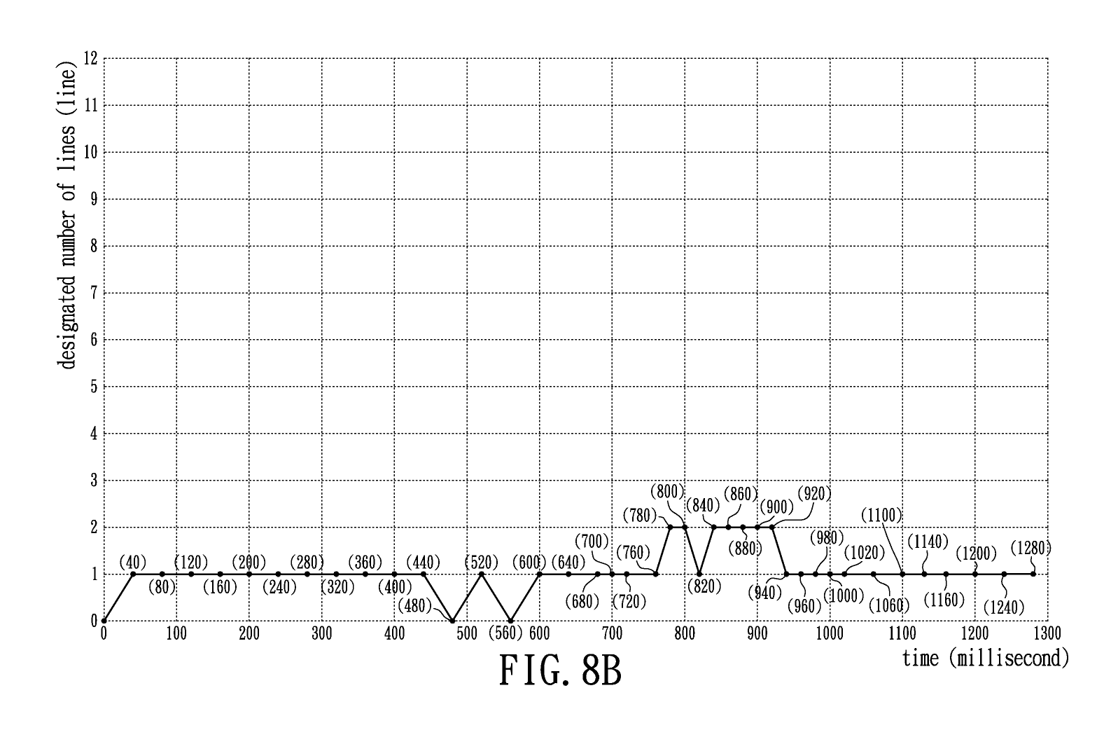

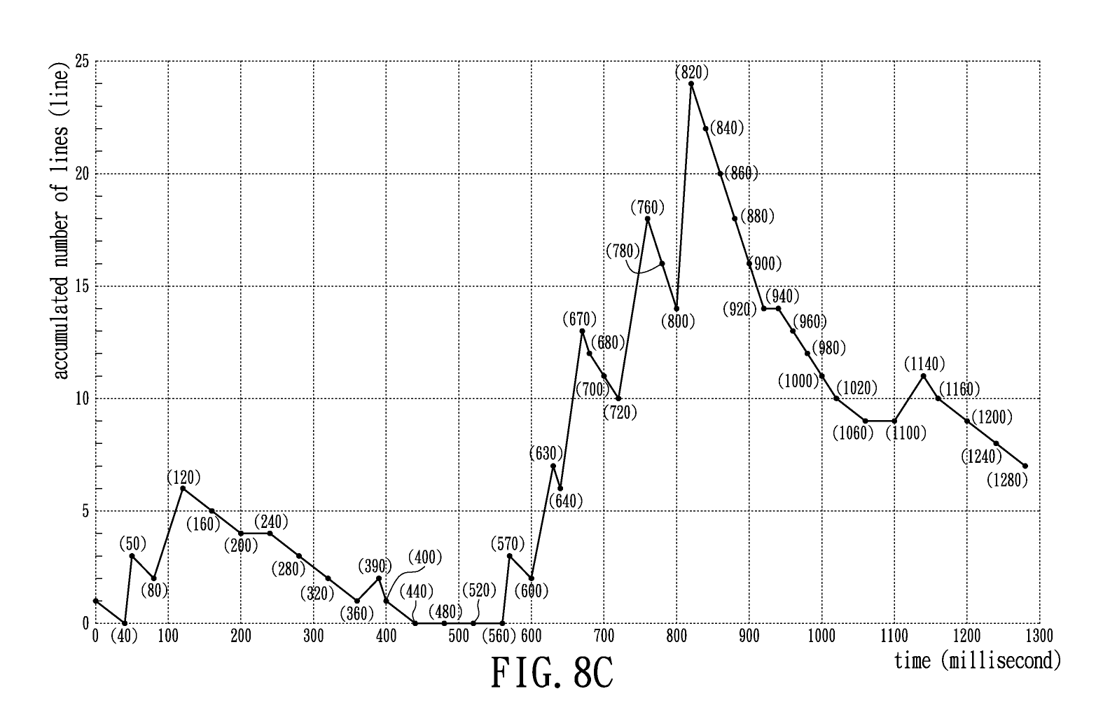

Referring to FIGS. 8A˜8C for the convenience of understanding the method for the control unit 104 to operate and adjust lines. The exemplary embodiment changes the period time with the aforementioned method of the example B.

The values set according to the embodiment of FIG. 7 are as follows: Suppose that the threshold time is 100 milliseconds. The basic number of lines is one line. The formula used by the control unit 104 is the arithmetic series with common difference of 2. The first threshold number of lines is ten lines. The second threshold number of lines is fifteen lines. The first period is 40 milliseconds. The second period may be 20 milliseconds. It is to be noted that the above-mentioned value is nothing but exemplary description, and the claim is not limited thereto. Table 1 shows the numbers of scrolling lines generated by simulating the rotations of the scrolling unit 100 with different speeds.

TABLE 1

| | Number of | | | Number of |
|---|---|---|---|---|
| Rolling | rolling | Rolling time | Time | scrolling |
| sequence | notches | (ms) | duration | lines |
| 1 | 1 | 0 | — | 1 |
| 2 | 1 | 50 | 50 | 3 |
| 3 | 1 | 120 | 70 | 5 |
| 4 | 1 | 240 | 120 | 1 |
| 5 | 1 | 390 | 150 | 1 |
| 6 | 1 | 520 | 130 | 1 |
| 7 | 1 | 570 | 50 | 3 |
| 8 | 1 | 630 | 60 | 5 |
| 9 | 1 | 670 | 40 | 7 |
| 10 | 1 | 760 | 90 | 9 |
| 11 | 1 | 820 | 60 | 11 |
| 12 | 1 | 940 | 120 | 1 |
| 13 | 1 | 1100 | 160 | 1 |
| 14 | 1 | 1140 | 40 | 3 |

The number of scrolling lines is corresponding to each calculation of rotating scrolling unit 100 according to Table 1. FIG. 8A shows a coordinate view of time v.s. the number of scrolling lines according to one embodiment of the instant disclosure. The number of scrolling lines of the longitudinal axis is calculated at the rolling time point of the scrolling unit 100 detected by the control unit 104, that is, it corresponds to the column of “Number of scrolling lines” in Table 1. Viewing from the time point of each notch rolled by the scrolling unit 100, the scrolling unit 100 at the time intervals t1, t3, and t5 operates in the fast-rolling mode, and thus the corresponding numbers of scrolling lines increase sequentially with the common difference of 2. On the contrary, during the time intervals t2 and t4 the scrolling unit 100 operates in the slow-rolling mode and the corresponding numbers of scrolling lines are all equal to one scrolling line.

Next, referring to FIG. 8B, FIG. 8B shows a coordinate view of time v.s. the designated number of scrolling lines executed by the computer 20 based on

The control command periodically generated by the control unit 104. The time point of generating each designated number of lines is a default or pre-determined value or happens periodically according to the period time determined by the control unit 104, such as 40 milliseconds or 20 milliseconds in the present embodiment. As shown in FIG. 8B, initially or pre-determinedly, each time when 40 milliseconds are expired, the control unit 104 outputs the control command including the designated number of lines. In conjunction with FIG. 8C showing a diagram of time v.s. the accumulated number of lines, it can be seen that at each time point of the rolling of the scrolling unit 100 (i.e. the column of “Rolling time” in Table 1), the number of scrolling lines is generated to increase the accumulated number of lines, but each time the first period (i.e. multiple of 40 milliseconds) is expired, the accumulated number of lines decreases. This is because after outputting the control command, the control unit 104 subtracts the designated number of lines from the accumulated number of lines. For instance, the numbers of scrolling lines accumulated by rolling the scrolling unit 100 are subtracted once every 40 milliseconds. When the first period is expired again at 440 milliseconds and the designated number of lines is subtracted, the input device 10 temporarily has no accumulated number of lines to output, and thus when the next first period is expired (i.e. 480 milliseconds), the control unit 104 at this time does not need to output the control command. Accordingly, as shown in FIG. 8B, the designated number of lines is zero at 480 milliseconds. The designated number of lines is also zero at 560 milliseconds.

Please keep referring to FIGS. 8B and 8C, after the scrolling unit 100 rotates the ninth notch (i.e. at 670 milliseconds), the accumulated number of lines has exceeded the first threshold number of lines (i.e. ten lines), and thus the control unit 104 may shorten the period time and change the period time from the first period to the second period of 20 milliseconds. Therefore, from the time at 670 milliseconds determining the accumulated number of lines exceeds the first threshold number of lines, the control unit 104 generates a designated number of lines every 20 milliseconds, wherein the designated number of lines in the present embodiment is the initial value or default value (e.g. one line). However, according to the method for calculating the period, the control unit 104 starts to count time with the first period at the 640 milliseconds. Therefore, the control unit 104 generates the control command at 680 milliseconds (i.e. after 10 milliseconds at 670 milliseconds), and then the control unit 104 generates the follow-up control command at 700 milliseconds and 720 milliseconds shown in FIG. 8B. As shown in FIG. 8C, the control unit 104 also respectively reduces one line of the accumulated number of lines at corresponding time point. At 720 milliseconds, the accumulated number of lines does not exceed the first threshold number of lines (i.e. ten lines), therefore the control unit 104 generates a next control command after 40 milliseconds (i.e. at 760 milliseconds). At 760 milliseconds, the control unit 104 detects again the tenth notch and then increase nine lines of number of scrolling lines. Because the first period is expired and the control unit 104 subtracts one line of designated number of lines at 760 milliseconds, the accumulated number of lines increases eight lines. After the period time reduces to 20 milliseconds, the control unit 104 detects the next notch and updates accumulated number of lines again. The designated number of lines may increase to two lines by the control unit 104 if the control unit 104 detects that the accumulated number of lines exceeds the second threshold number of lines (i.e. fifteen lines). The designated number of lines shown in FIG. 8 is 2 at 780 and 800 milliseconds.

At 820 milliseconds, the control unit 104 detects again the eleventh notch and increases eleven lines of number of scrolling lines, therefore the accumulated number of lines after updating still exceeds the first threshold number of lines and the second threshold number of lines. Because the second period time has accelerated to be 20 milliseconds and the accumulated number of lines is still larger than the second threshold number of lines, the control unit 104 subtracts the value of the designated number of lines so as to increase the speed of eliminating the accumulated number of lines. Taking the example of enhancing two lines for explanation, referring to FIG. 8B, the control unit 104 continuously outputs the control command with the second period (20 milliseconds) and instructs the computer 20 scrolling two lines from the 820 milliseconds. Meanwhile, the document of the computer 20 may scroll quickly and significantly so as to make the accumulated number of lines be eliminated quickly. In conjunction with FIG. 8C, from the 820 milliseconds, the accumulated number of lines reduces quickly until the 920 milliseconds. The accumulated number of lines is lower than the second threshold number of lines (i.e. fifteen lines) from the 920 milliseconds, and then the control unit 104 makes the designated number of lines revert to one line, wherein the designated number of lines is the number for subtracting each time. When the scrolling unit 100 rolls again at 940 milliseconds and the control unit 100 determines the accumulated number of lines after updating is lower than the second threshold number of lines, the control unit 104 maintains the designated number of lines one line, wherein the designated number of lines is the number for subtracting each time. Afterwards, as shown in FIG. 8B, the accumulated number of lines does not exceed the first threshold number of lines from 1020 milliseconds to 1100 milliseconds, and the control unit 104 makes the designated number of lines revert to one line with the first period, wherein the designated number of lines is the number for subtracting each time. Next, the control unit 104 detects again the fourteenth notch so as to increase the number of scrolling lines of three lines, therefore the accumulated number of lines after updating exceeds the first threshold number of lines (i.e. ten lines) again. The control unit 104 periodically subtracts the designated number of lines of one line with the second period (i.e. twenty milliseconds) from 1140 milliseconds, that is, the control unit 104 subtracts the designated number of lines of one line at 1160 milliseconds. Finally, since the accumulated number of lines does not exceed the first threshold number of lines from 1160 milliseconds, the control unit 104 makes the designated number of lines revert to one line with the first period (i.e. forty milliseconds), wherein the designated number of lines is the number for subtracting each time, so that the accumulated number of lines may be gradually reduced with slightly increasing of the number of scrolling lines and periodically subtracting of the designated number of lines.

According to the aforementioned embodiments of the instant disclosure, the input device and scrolling speed control method thereof of the instant disclosure may dynamically adjust with the speed of the scrolling unit of the input device operated by the user so as to instruct the computer scrolling the number of scrolling lines of the document, and thus the computer may scroll the document slightly when the control unit is in the slow-rolling mode; the computer may scroll the document significantly when the control unit is in the fast-rolling mode.

Furthermore, according to the disclosure of the above-mentioned preferred embodiments, the input device and scrolling speed control method thereof of the instant disclosure may still accelerate the computer for scrolling the document when the scrolling unit of the input device operates in the fast-rolling mode for longer time so as to accumulate lots of the number of scrolling lines waiting for scrolling. Specifically, according to the aforementioned preferred embodiments, the instant disclosure may enhance the frequency of scrolling the document for the computer through increasing the speed of transmitting the control command at least and increasing the number of lines for scrolling the document, so that the control unit may progressively increase the range and the speed of scrolling the document when the user rotates the scrolling unit for a period of time.

Additionally, according to the aforementioned preferred embodiments, under the premise of no change in the structure of the hardware or under the premise without increasing component, the input device of the instant disclosure may achieve the above effect through executing the software or firmware programs by the control unit.

Therefore, the instant disclosure may reduce the times of operating the scrolling unit and the discomfort due to excessive use of the user's hand when the user scroll the lengthy document. Moreover, the instant disclosure may still enhance the user's experience of good use.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An input device adapted for connecting to a computer, comprising:
a scrolling unit, rolling one or more notches according to an operation, each notch being rolled by the scrolling unit corresponding to a number of scrolling lines associated with a document in the computer; and
a control unit, connected to the scrolling unit, calculating a time duration between two adjacent notches rolled by the scrolling unit so as to determine whether the scrolling unit is rolling in a fast-rolling mode or in a slow-rolling mode, accumulating the respective numbers of scrolling lines corresponding to the respective notches being rolled by the scrolling unit to generate an accumulated number of lines, and outputting a control command to the computer to instruct the computer to scroll the document according to a designated number of lines,
wherein when the time duration is smaller than or equal to a threshold time, the control unit determines that the scrolling unit rolls in the fast-rolling mode, and progressively increases the number of scrolling lines corresponding to each notch being rolled by the scrolling unit in the fast rolling mode, and
wherein the control unit subtracts the designated number of lines instructed by the control command from the accumulated number of lines.

2. The input device according to claim 1, wherein when the time duration is larger than the threshold time, the control unit determines that the scrolling unit rolls in the slow-scrolling mode, and assigns a basic number of lines to the number of scrolling lines corresponding to each notch rolled by the scrolling unit in the slow-rolling mode.

3. The input device according to claim 1, wherein when the scrolling unit is in the fast-rolling mode, the control unit sets the number of scrolling lines corresponding to each notch to progressively increase in an arithmetic manner or in a geometric manner.

4. The input device according to claim 1, wherein the control unit outputs the control command according to a first period to the computer so as to instruct the computer to scroll the document according to the designated number of lines.

5. The input device according to claim 4, wherein when the control unit determines the accumulated number of lines exceeding a first threshold number of lines, the control unit periodically outputs the control command according to a second period which is shorter than the first period.

6. The input device according to claim 5, wherein when the control unit determines the control command outputting according to the second period but the accumulated number of lines not exceeding the first threshold number of lines, the control unit turns to output the control command according to the first period.

7. The input device according to claim 5, wherein when the control unit periodically outputs the control command according to the second period and determines that the accumulated number of lines exceeds a second threshold number of lines, the control unit increases a value of the designated number of lines; and when the control unit periodically outputs the control command according to the second period and determines that the accumulated number of lines does not exceed the second threshold number of lines, the control unit sets the value of the designated number of lines to a initial value.

8. A method of controlling a scrolling speed of an input device connecting to a computer, comprising:
detecting a rolling state of a scrolling unit of the input device when the input device is in operation, wherein the scrolling unit rolls one or more notches according to operation, and each notch rolled by the scrolling unit corresponds to a number of scrolling lines associated with a document in the computer;
calculating a time duration between two adjacent notches when the scrolling unit rolling;
determining whether the time duration is smaller than or equal to a threshold time;
determining that the scrolling unit rolls in a fast-rolling mode, and progressively increasing the respective numbers of scrolling lines corresponding to the respective notches being rolled by the scrolling unit when the time duration is smaller than or equal to the threshold time;
accumulating the numbers of scrolling lines corresponding to the notches rolled by the scrolling unit to be an accumulated number of lines;
outputting a control command to the computer so as to instruct the computer to scroll the document according to a designated number of lines instructed by the control command; and
subtracting the designated number of lines from the accumulated number of lines.

9. The method according to claim 8, after the step of determining whether the time duration is smaller than or equal to a threshold time further comprising:
determining that the scrolling unit rolls in a slow-rolling mode when the time duration is larger than the threshold time, and assigning a basic number of lines to be the number of scrolling lines corresponding to each notch rolled by the scrolling unit.

10. The method according to claim 8, after accumulating the numbers of scrolling lines corresponding to the notches to be an accumulated number of lines further comprising:
determining whether the accumulated number of lines exceeds a first threshold number of lines;
outputting the control command periodically according to a first period when the accumulated number of lines does not exceed the first threshold number of lines; and
outputting the control command periodically according to a second period when the accumulated number of lines exceeds the first threshold number of lines, wherein the second period is shorter than the first period.

11. The method according to claim 10, wherein the step of outputting the control command periodically according to the second period comprises:
increasing the designated number of lines instructed by the control command when the accumulated number of lines exceeds a second threshold number of lines.

12. The method according to claim 8, after accumulating the accumulated number of lines further comprising:
returning to the step of detecting a rolling state of the scrolling unit of the input device.

13. The method according to claim 8, wherein the step of outputting the control command to the computer so as to instruct the computer to scroll the document according to the designated number of lines when the input device is in operation comprises:
determining whether a period time is expired;
returning to the step of detecting the rolling state of the scrolling unit of the input device when the period time is not expired;
determining whether the accumulated number of lines is larger than zero when the period time is expired;
returning to the step of detecting the rolling state of the scrolling unit of the input device when the accumulated number of lines is not larger than zero; and
generating the control command to the computer when the accumulated number of lines is larger than zero.

14. The method according to claim 13, wherein after subtracting the designated number of lines instructed by the control command from the accumulated number of lines further comprises:
returning to the step of determining whether the period time is expired.
